(19) United States
(12) Patent Application Publication
(10) Pub. No.: US 2013/0277361 A1
(43) Pub. Date: Oct. 24, 2013

(54) APPARATUS AND METHOD OF INTERCONNECTING A PLURALITY OF SOLAR CELLS

(71) Applicants: Lian Hok TAN, Singapore (SG); Wen Ge TU, Singapore (SG); Pan YANG, Singapore (SG)

(72) Inventors: Lian Hok TAN, Singapore (SG); Wen Ge TU, Singapore (SG); Pan YANG, Singapore (SG)

(21) Appl. No.: 13/450,636

(22) Filed: Apr. 19, 2012

(51) Int. Cl. B23K 1/002; B23K 3/08; B23K 26/20; B23K 3/047; B23K 1/20; B23K 31/02; B23K 3/04

(52) U.S. Cl. 219/616; 228/101; 228/49.1; 228/9; 228/13; 228/4.1; 219/121.65

(57) ABSTRACT

Disclosed is an apparatus for electrically interconnecting a plurality of solar cells. The apparatus comprises: i) a roller operative to roll along a solar cell to press an electrical conductor against an electrical contact of the solar cell, the electrical conductor being for electrically interconnecting the solar cell with one or more other solar cells; and ii) a heat-generating device arranged and configured to provide heat for soldering the electrical conductor to the electrical contact of the solar cell while the roller is pressing the electrical conductor against the electrical contact of the solar cell. A method of electrically interconnecting a plurality of solar cells, and a mechanism for laying and soldering an electrical conductor onto a solar cell, are also disclosed.

### FIELD OF THE PRESENT INVENTION

This invention relates to an apparatus and method of electrically interconnecting a plurality of solar cells, in which an electrical conductor is used to electrically interconnect a solar cell with one or more other solar cells.

### BACKGROUND OF THE INVENTION

Solar cells are electrical devices that convert light energy into electrical energy based on the photovoltaic (‘PV’) effect. Each solar cell is fabricated from a solar wafer belonging to either a mono-crystalline or multi-crystalline type. A fabricated solar cell normally includes metallic front and back contacts known as busbars' that may be made up of silver and/or silver with aluminum. The solar cell is then interconnected with a number of other solar cells in series to form a string, and finally, a solar cell array formed by interconnecting a number of parallel strings together.

FIG. 1 is an isometric view of two solar cells 104, 106 electrically interconnected to each other using conductive ribbons 102. Specifically, three electrical conductors (shown as conductive ribbons 102) are first soldered onto busbars 103a at the front of a first solar cell 104, and are then bent downwards before they are soldered onto busbars 103b (hidden from view in FIG. 1) at the back of a second solar cell 106 arranged at a distance of several millimeters (e.g. from 2 mm up to 40 mm) proximate to the first solar cell 104. In particular, the conductive ribbons 102 are joined to the busbars 103a, 103b of the solar cells 104, 106 via a heated soldering medium. One example of the soldering medium includes flux, which enhances the formation of an electrically conductive intermetallic layer between the conductive ribbons 102 and the busbars 103a, 103b of the respective solar cells 104, 106.

Typically, 2 to 16 solar cells could be electrically interconnected to form a string. The process of attaching the electrical conductors to the solar cells 104, 106 is called ‘tabbing’, while the process of interconnecting the various solar cells together to form a string is called ‘stringing’. A typical solar array has around 2 to 8 parallel strings that are electrically interconnected to one another. The power output of the completed solar array is thus the product of the voltage generated by each string (i.e. the voltage generated by each solar cell multiplied by the number of solar cells in each string) and the sum of the currents generated by all the strings (i.e. the current of each string multiplied by the number of strings).

Cell interconnection has been recognized to be the most critical process with respect to production yield and module efficiency. If the process is not carefully controlled, the likelihood of cracks forming in the solar cells or the solar cells breaking would increase. This is because thermal mismatch in the Coefficient of Thermal Expansion (‘CTE’) between the conductive ribbons and the busbars results in mechanical stress forming between them. Consequently, if the solder solidification point, the cooling speed, the material cross-sections and the ductility of the electrical conductor are not carefully chosen, the solar cell may crack or even break during the cell interconnection process. Improper cell interconnection may also affect solar energy to electrical energy conversion of the solar array.

Thus, it is an object of the present invention to seek to eliminate, or at least minimize, the likelihood of cell crack formation and/or cell breakage during the cell interconnection process. In addition, this invention also seeks to improve the soldering quality between an electrical conductor and an electrical contact of a solar cell. Finally, the invention also seeks to provide an integrated system for simultaneous tabbing and/or stringing to solar cells.

### SUMMARY OF THE INVENTION

A first aspect of the invention is an apparatus for electrically interconnecting a plurality of solar cells. The apparatus comprises: i) a roller operative to roll along a solar cell to press an electrical conductor against an electrical contact of the solar cell, the electrical conductor being for electrically interconnecting the solar cell with one or more other solar cells; and ii) a heat-generating device arranged and configured to provide heat for soldering the electrical conductor to the electrical contact of the solar cell while the roller is pressing the electrical conductor against the electrical contact of the solar cell.

By having the roller operative to roll along the solar cell to press the electrical conductor against the electrical contact of the solar cell, the electrical conductor may be continuously and uniformly soldered to the solar cell. Additionally, a free end of the electrical conductor that has not been soldered to the electrical contact of the solar cell is allowed to expand upon heating by the heat-generating device. This accordingly minimizes the effect of the thermal mismatch in the CTE between the electrical conductor and the electrical contact of the solar cell, and advantageously improves the soldering quality.

Some optional but preferred features of the apparatus have been defined in the dependent claims.

For example, the heat-generating device may comprise an inductor loop for generating a magnetic field to induce an electrical current in the electrical contact of the solar cell to thereby generate heat for soldering the electrical conductor thereto. The inductor loop may be arranged around the roller. In this way, the magnetic field generated by the inductor loop may be directed axially on the electrical conductor and the electrical contact of the solar cell for soldering. Further, the roller may comprise diamagnetic material for concentrating the magnetic field generated by the inductor loop within a space enclosed by the inductor loop. This concentrates the magnetic field generated by the inductor loop within a space enclosed by the inductor loop, and advantageously maximizes energy and power efficiency.

A second aspect of the invention is a method of electrically interconnecting a plurality of solar cells. The method comprises the steps of: laying an electrical conductor on an electrical contact of a solar cell; pressing the electrical conductor against the electrical contact of the solar cell, the electrical conductor being for electrically interconnecting the solar cell with one or more other solar cells; and providing heat to solder the electrical conductor to the electrical contact of the solar cell. In particular, the step of pressing the electrical conductor against the electrical contact of the solar cell comprises rolling a roller along the solar cell to press the electrical conductor against the electrical contact of the solar cell as heat is being provided to solder the electrical conductor to the solar cell.

Some optional but preferred steps of the method have also been defined in the dependent claims. For example, the step of providing heat to solder the electrical conductor to the electrical contact of the solar cell may comprise generating a magnetic field with an inductor loop to induce an electrical current in the electrical contact of the solar cell to thereby generate heat for soldering the electrical conductor thereto. Further, the step of providing heat to solder the electrical conductor to the electrical contact of the solar cell may comprise intermittently generating the magnetic field with the inductor loop to solder the electrical conductor to selective portions of the electrical contact of the solar cell.

A third aspect of the invention is a mechanism for laying and soldering an electrical conductor onto a solar cell. Specifically, the mechanism comprises: i) the apparatus according to the first aspect of the invention for laying and soldering the electrical conductor onto the solar cell; and ii) a dispensing device for providing the electrical conductor to the apparatus according to the first aspect of the invention.

### BRIEF DESCRIPTION OF THE DRAWINGS

Preferred embodiments of the invention will now be described, by way of example only, with reference to the accompanying drawings, of which:

FIG. 1 is an isometric view of two solar cells electrically interconnected to each other using conductive ribbons based on the conventional H-format solar cell soldering method;

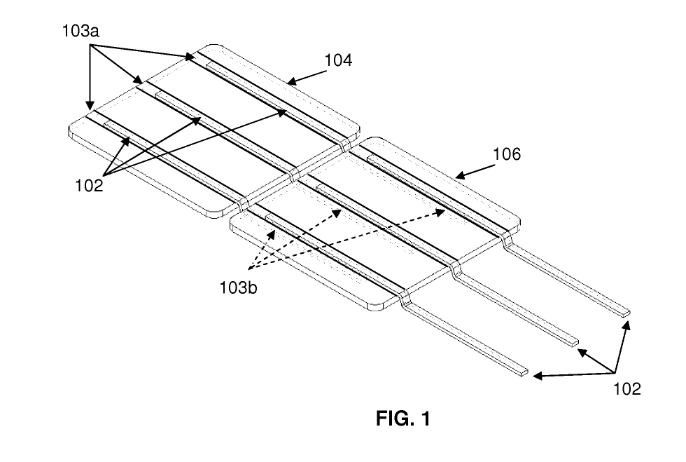

FIG. 2a is an isometric view of a soldering device for soldering an electrical conductor to a solar cell according to a first preferred embodiment of the invention;

FIG. 2b and FIG. 2c are different side views of the soldering device of FIG. 2a;

FIGS. 3a-3d illustrate an operation of the soldering device of FIG. 2a;

FIGS. 4a-4e show other preferred embodiments of the soldering device for soldering an electrical conductor to a solar cell;

FIG. 5 shows an integrated mechanism for laying and soldering a conductive ribbon onto a solar cell, comprising a soldering chassis and the soldering device of FIG. 2a; and

FIG. 6 shows the soldering chassis of the integrated mechanism of FIG. 5.

### DETAILED DESCRIPTION OF THE PREFERRED EMBODIMENTS

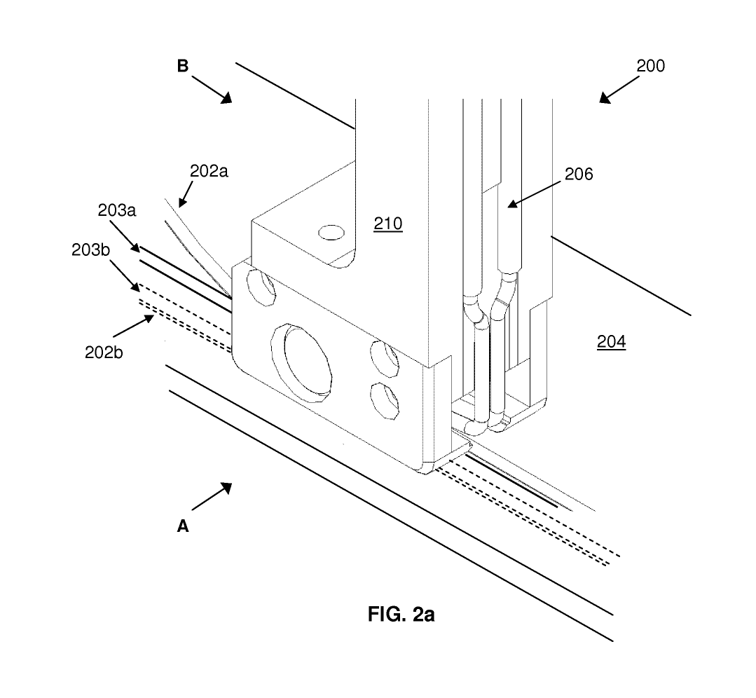

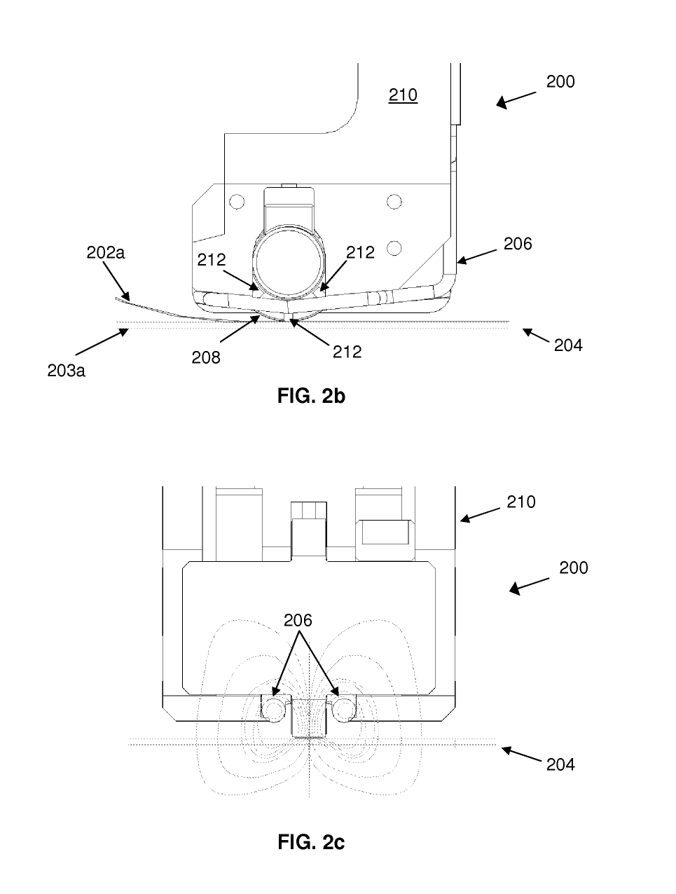

FIG. 2a is an isometric view of a soldering device 200 according to a first preferred embodiment of the present invention, while FIG. 2b and FIG. 2c are respective side views of the soldering device 200 when viewed along directions A and B shown in FIG. 2a.

In particular, the soldering device 200 is configured to solder an electrical conductor (shown as conductive ribbons 202a, 202b) to an electrical contact (e.g. a busbar 203a on a front surface and a busbar 203b on a back surface) of a solar cell 204, so as to electrically interconnect the solar cell 204 with one or more other solar cells (not shown) to form a string.

The soldering device 200 comprises: i) a heat-generating device (shown as an inductor loop 206) for providing heat to solder the conductive ribbons 202a, 202b to the busbars 203a, 203b of the solar cell 204; ii) a roller (shown as a wheel 208 in FIG. 2b) installed within the inductor loop 206 for rolling along the solar cell 204 to press the conductive ribbon 202a against the busbar 203a, as the inductor loop 206 provides heat for soldering; and iii) a chassis 210 for housing the inductor loop 206 and the wheel 208.

Specifically, the inductor loop 206 comprises an inductor coil connected to a high-frequency (e.g. 900 KHz) alternating current generator. When a high-frequency alternating current flows through the inductor loop 206, a magnetic field is accordingly produced around the inductor loop 206 (illustration shown in FIG. 2c). The strength of the magnetic field depends on the strength of the high-frequency alternating current passing through the coil, as well as the number of turns in the inductor coil.

The magnetic field accordingly induces eddy currents along the conductive ribbons 202a, 202b and the busbars 203a, 203b of the solar cell 204. Due to resistance in the conductive ribbons 202a, 202b and the busbars 203a, 203b, heat is thus produced which thereby melts a layer of alloy (e.g. Tin-Silver-Lead alloy) in each of the conductive ribbons 202a, 202b to join to the respective busbar 203a, 203b of the solar cell 204 via induction soldering. Induction heating is generally preferred as a means of heat generation due to its production of fast, clean and consistent heat.

The length of the inductor loop 206 is between 1/10 and ⅛ of the length of the solar cell 204 (which typically measures between 10-15 cm), while the width of the inductor loop 206 is between 2-5 mm. Since the magnetic flux density of the generated magnetic field decreases from the center of the inductor loop 206 towards its sides, these short dimensions of the inductor loop 206 allow as much of the magnetic field to be axially concentrated on the conductive ribbons 202a, 202b and the busbars 203a, 203b as possible. Thus, the inductor loop 206 may advantageously provide uniform soldering of the conductive ribbon 202a, 202b to the solar cell 204. Nevertheless, it should of course be appreciated that other length and width of the inductor loop 206 may also be possible.

The wheel 208 comprises a plurality of diamagnetic cores (shown in FIG. 2b as ‘212’) evenly distributed around the wheel's circumference. These diamagnetic cores 212 may either comprise paramagnetic material or soft magnetic material with high permeability. By providing the diamagnetic cores 212 around the wheel's circumference, a larger magnetic flux density of the magnetic field can be confined and guided axially onto the conductive ribbons 202a, 202b and the busbars 203a, 203b. Referring to FIG. 2c, it can be seen from that the magnetic field generated by the inductor loop 206 is most concentrated within a space enclosed by the inductor loop 206. This is because the diamagnetic cores 212 are capable of minimizing the dispersal of the generated magnetic field into the ambient surroundings and increasing the magnetic flux density directed axially on the conductive ribbons 202a, 202b and the busbars 203a, 203b. Advantageously, the energy and power efficiency of the high-frequency alternating current generator may be maximized. Also, the higher concentration of the magnetic flux density on the conductive ribbons 202a, 202b and the busbars 203a, 203b could provide continuous and uniform soldering of the conductive ribbon 202a, 202b to the busbars 203a, 203b of the solar cell 204, as the wheel 208 rolls along the solar cell 204 to press the conductive ribbon 202a against the busbar 203a. Moreover, the diamagnetic cores 212 may reduce the difference in the magnetic flux density of the generated magnetic field between the front and back busbars 203a, 203b of the solar cell 204 to effectively perform simultaneous soldering to the conductive ribbons 202a, 202b. Nevertheless, it should of course be appreciated that the wheel 208 may also be entirely made up of non-magnetic material.

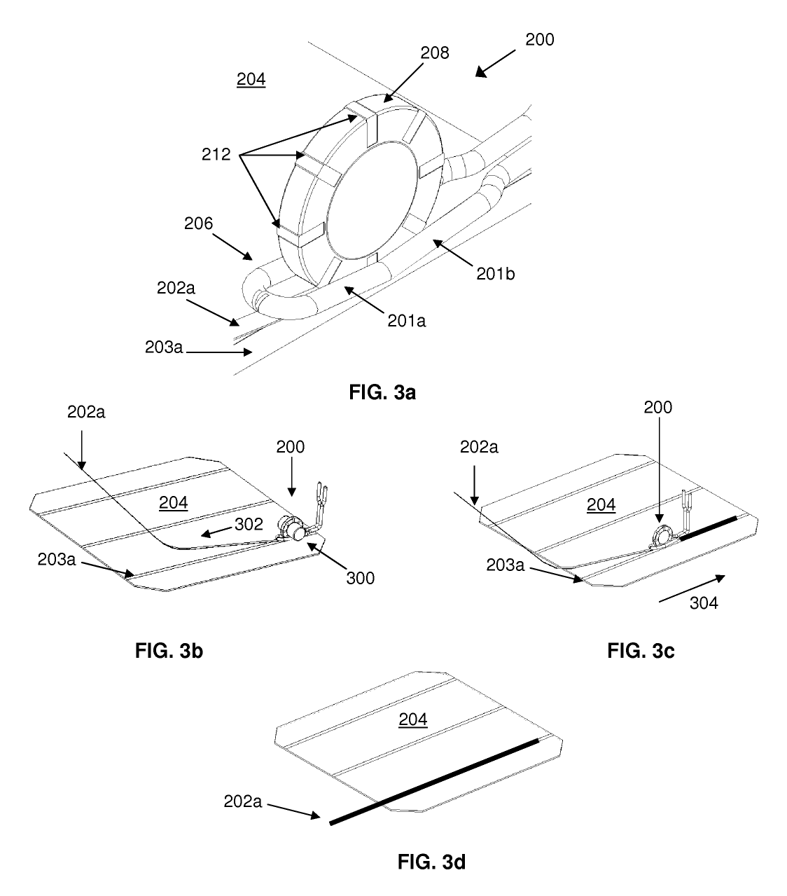

FIGS. 3a-3d illustrate the soldering device 200 performing the ‘tabbing-and-stringing’ technique of cell interconnection. For the purpose of explanation, FIGS. 3a-3d do not show the chassis 210 of the soldering device 200.

Referring to FIG. 3a, it can be seen that the inductor loop 206 includes a front section 201a and a back section 201b inclined at an angle not more than 45 degree with respect to a surface of the solar cell 204 in a direction along which the soldering device 200. For example, the front and back sections 201a, 201b may be arranged at an angle of between 2 to 3 degrees with respect to the surface of the solar cell 204. Thus, the front section 201a of the inductor loop 206 can be used for pre-heating before the cell interconnection process, whereas the back section 201b of the inductor loop 206 can be used for post-heating after the cell interconnection process. Indeed, the back section 201b of the inductor loop 206 may be used for pre-heating while the front section 201a may be used for post-heating, depending on the direction along which the inductor loop 206 moves. In particular, the conductive ribbons 202a, 202b and the busbars 203a, 203b are continuously heated by the inductor loop 206 as the wheel 208 moves along the solar cell 204 to gently press the conductive ribbon 202a against the busbar 203a. Thus, a free end of each of the conductive ribbons 202a, 202b that has not been soldered to the respective busbar 203a, 203b is allowed to expand upon heating by the inductor loop 206. This accordingly minimizes the tension caused by the effect of the thermal mismatch in the CTE between the conductive ribbons 202a, 202b and the busbars 203a, 203b, and advantageously improves the soldering quality. In contrast, conventional solar cells themselves are typically pre-heated before the cell interconnection process, but this may result in mechanical stress and/or warpage of the solar cells. (Warpage is a distortion where the surfaces of a molded part do not follow the intended shape of the design.)

Before the cell interconnection begins, the soldering device 200 is mounted to a positioning arm that is first driven and guided by a motor (not shown) until the chassis 210 is about 0.5-0.7 mm above the solar cell 204. This is because the bottom of the chassis 210 includes an opening out of which a portion of the wheel 208 protrudes, for example by a length of about 0.5-0.7 mm. Thus, by positioning the chassis 210 about 0.5-0.7 mm above the solar cell 204, the wheel 208 will be able to press the conductive ribbon 202a via a pressure point (e.g. via a length of between 2-10 mm) against the busbar 203a of the solar cell 204 with a ‘soft-touch’ feature.

FIG. 3b shows an original starting position 300 of the soldering device 200 for the cell interconnection process. During operation, the soldering device 200 is accordingly driven by the motor so that the wheel 208 rolls along the conductive ribbon 202a in the direction shown by the arrow 302, and presses the conductive ribbon 202a against the busbar 203a as heat is generated through the inductor loop 206 by the induced eddy currents along the conductive ribbons 202a, 202b and the busbars 203a, 203b. In particular, the conductive ribbons 202a, 202b are provided by a ribbon-dispensing device comprising a reel of conductive ribbon. The ribbon-dispensing device is also configured and operative to provide and to lay the conductive ribbon 202a on the busbar 203a of the solar cell 204. By controlling the power supplied to the alternating current generator and/or the arrangement of the diamagnetic material within the wheel 208, the conductive ribbon 202a may be continuously or selectively soldered to the busbar 203a of the solar cell 204. For example, the inductor loop 206 may intermittently generate the magnetic field to solder the conductive ribbons 202a, 202b to selective portions of the busbars 203a, 203b of the solar cell 204.

FIG. 3c shows the conductive ribbon 202a being soldered to half the length of the busbar 203a, whereas FIG. 3d shows the conductive ribbon 202a being soldered to the entire length of the busbar 203a. As the solar cell 204 relates to the conventional H-format solar cell for double-surface soldering, the conductive ribbon 202a is then further extended and bent downwards by the ribbon-dispensing device. The conductive ribbon 202a is then cut by a cutting device (not shown) to detach it from the ribbon spool of the ribbon-dispensing device. Thereafter, the solar cell 204 and the extended conductive ribbon 202a is moved by a conveyor belt (not shown) in the direction shown by the arrow 304 by the length of the solar cell 204. A new solar cell is subsequently placed on the extended conductive ribbon 202a, before the soldering device 200 is accordingly driven by the motor to its original starting position 300. In particular, the new solar cell is placed on the conductive ribbon 202a such that its back busbar is aligned with the conductive ribbon 202a for soldering. Thereafter, ribbon-dispensing device accordingly lay another length of the conductive ribbon from the reel of the conductive ribbon on the corresponding front busbar of the new solar cell, before the soldering device 200 again rolls against the newly-dispensed conductive ribbon to press it against the front busbar of the new solar cell for soldering both the conductive ribbon 202a (aligned along the back busbar of the new solar cell) and the newly-dispensed conductive ribbon (aligned along the front busbar of the new solar cell) to the new solar cell. Thus, the solar cell 204 can be electrically interconnected with the new solar cell. By repeating the above process, the solar cell 204 can be electrically interconnected with various other solar cells to form a string.

By moving the wheel 208 of the soldering device 200 to press the conductive ribbon 202a against the front busbar 203a of the solar cell 204, the conductive ribbon 202a can be continuously and uniformly soldered to the solar cell 204. In addition, the conductive ribbons 202a, 202b and the busbars 203a, 203b are continuously heated by the inductor loop 206 as the wheel 208 moves along the solar cell 204 to press the conductive ribbon 202a against the busbar 203a. Thus, a free end of each of the conductive ribbons 202a, 202b that has not been soldered to the respective busbar 203a, 203b is allowed to expand upon heating by the inductor loop 206. This accordingly minimizes the effect of the thermal mismatch in the CTE between the conductive ribbons 202a, 202b and the busbars 203a, 203b, and advantageously improves the soldering quality. Thus, the wheel 208 with its soft-touch feature provides uniform soldering and advantageously minimizes the mechanical stress due to the thermal mismatch in the CTE between the conductive ribbons 202a, 202b and the busbars 203a, 203b of the solar cell 204.

Although FIG. 3a-3d show a single soldering device 200 for soldering the conductive ribbon 202a to the front busbar 203a of the solar cell 204, it should be appreciated that other identical or similar soldering devices may be used to simultaneously solder other conductive ribbons to other front and back busbars of the solar cell 204. Moreover, since the solar cell 204 relates to a conventional H-format solar cell for double-surface soldering, it should be appreciated that the induction loop 206 is operative to induce eddy currents along the conductive ribbon 202b and the back busbar 203b of the solar cell 204, so that soldering between the conductive ribbon 202b and the back busbar 203b is simultaneously performed while the conductive ribbon 202a is being soldered to the front busbar 203a of the solar cell 204. Further, it should be appreciated that the soldering device 200 could be operative to perform single-surface soldering for solar cells that employ conductive ribbons to only one side of the solar cells (i.e. the all-back-contact methodology).

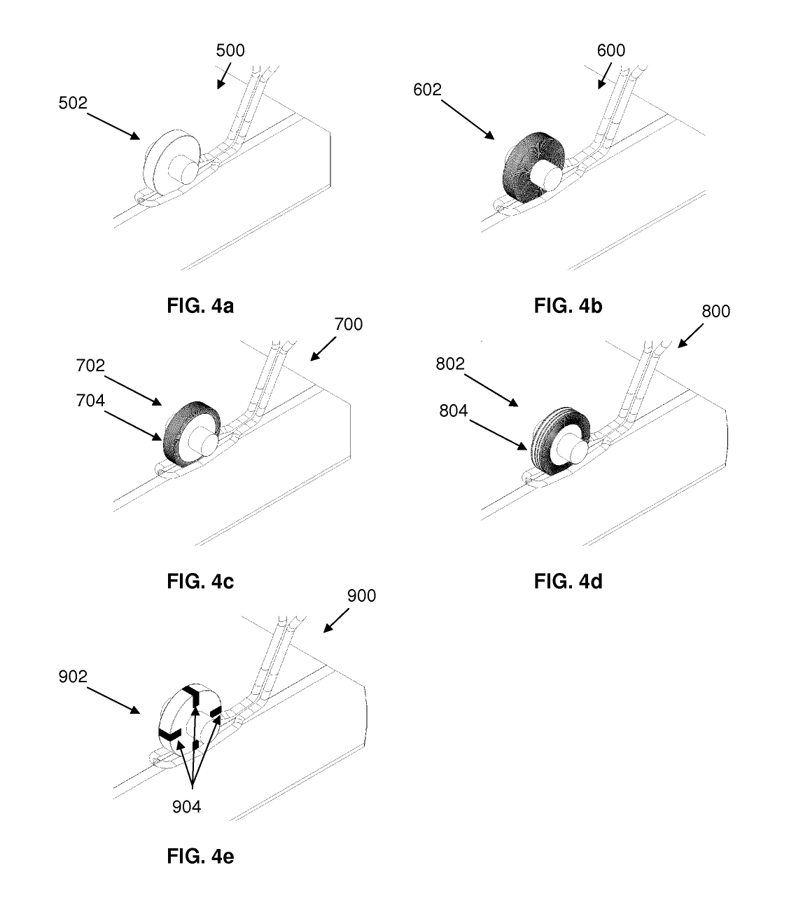

Other embodiments are also possible without departing from the scope of the present invention. For instance, FIG. 4a shows a soldering device 500 according to a second preferred embodiment of the invention having a non-magnetic wheel 502. FIG. 4b shows a soldering device 600 according to a third preferred embodiment of the invention having a wheel 602 that is entirely made up of a diamagnetic material of high permeability. FIG. 4c shows a soldering device 700 according to a fourth preferred embodiment of the invention having a wheel 702 that comprises a diamagnetic O-ring 704, while FIG. 4d shows a soldering device 800 according to a fifth preferred embodiment of the invention having a wheel 802 that comprises a plurality of diamagnetic O-rings 804. Also, FIG. 4e shows a soldering device 900 according to a sixth preferred embodiment of the invention having a wheel 902 that comprises four diamagnetic cores 904 evenly arranged around the wheel's circumference. Of course, it should also be appreciated that these diamagnetic cores may be unevenly distributed around the wheel's circumference. Moreover, the wheel of the soldering device may also include any number of the diamagnetic cores around the wheel's circumference.

In addition, it should be appreciated that the various preferred embodiments of the soldering device described above can simultaneously perform the processes of tabbing (which is the process of attaching conductive ribbons to solar cells) and stringing (which is the process of interconnecting various solar cells together to form a string) in real-time. Advantageously, a fully integrated and compact apparatus—which comprises the ribbon-dispensing device for dispensing and laying the conductive ribbon onto the solar cell, the soldering device for electrically interconnecting a plurality of solar cells, and a cutting device for cutting the conductive ribbon to detach it from the ribbon-dispensing device—may be provided to perform tabbing and stringing of solar cells simultaneously for the manufacture of solar panels.

Further, although the inductor loop has been mainly described as the heat-generating device among the various embodiments of the soldering device, it should be appreciated that other forms of heat-generating device may also be used. Examples of other forms of heat-generating device may include lasers, infrared-red (IR) lamps, soldering irons, or hot air blowers. Similarly, any of these other forms of heat-generating device may also be operative to intermittently generate heat to solder an electrical conductor to selective portions of an electrical contact of a solar cell.

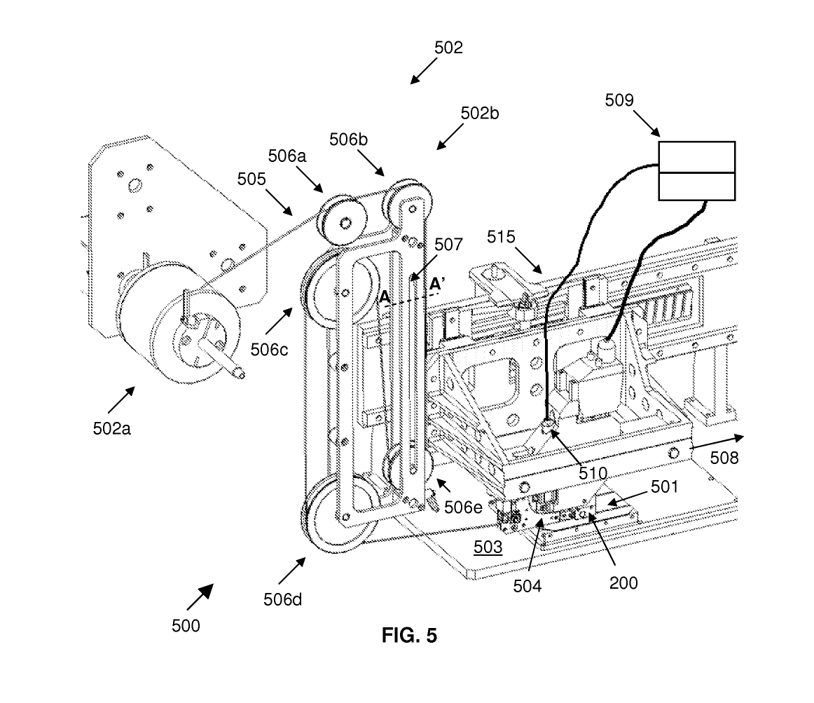

FIG. 5 shows an integrated mechanism 500 for laying and soldering an electrically conductive ribbon 505 onto a solar cell 501. In addition to the soldering device 200 described above, the integrated mechanism 500 also comprises: i) a support device 503 for supporting the solar cell 501; ii) a ribbon-dispensing device (shown as a ribbon handler 502) for providing the conductive ribbon 505 to the soldering device 200; and iii) a soldering chassis 504, which is mounted to a positioning arm 515, for housing the soldering device 200. In particular, the ribbon handler 502 includes: i) a ribbon reel holder 502a for holding a reel of the conductive ribbon 505; and ii) a buffer unit 502b positioned between the ribbon reel holder 502a and the soldering device 200. Essentially, the buffer unit 502b is a multi-pulley arrangement for providing the conductive ribbon 505 to the soldering device 200, comprising a plurality of fixed pulleys 506a-d and a movable pulley 506e configured to move along a linear slot 507 during operation.

During operation, the soldering device 200 moves together with the soldering chassis 504 along the positioning arm 515 in a direction as shown by arrow 508 in FIG. 5 to pull a desired length of the conductive ribbon 505 from the ribbon handler 502. Accordingly, the desired length of the conductive ribbon 505 can be laid on the solar cell 501. As the conductive ribbon 505 is pulled away from the ribbon handler 502 by the soldering device 200, the movable pulley 506e accordingly moves upwards along the linear slot 507. This provides an additional length of the conductive ribbon 505 from the ribbon handler 502 to the solar cell 501 whilst maintaining the tension of the conductive ribbon 505 between the ribbon handler 502 and the soldering device 200.

The integrated mechanism 500 may additionally comprise a touch sensor (not shown) positioned along the linear slot 507 (for instance, along line A-A′ as shown in FIG. 5) to detect the position of the movable pulley 506e as it moves upwards along the linear slot 507. When the movable pulley 506e is detected by the touch sensor, a signal is sent to a processor (not shown) connected between the ribbon handler 502 and the soldering chassis 504. Upon detecting the signal from the touch sensor, the processor accordingly sends a corresponding signal to the ribbon handler 502 to dispense an additional length of the conductive ribbon 505 to the soldering device 200. Specifically, the ribbon reel holder 502a unwinds to release the additional length of the conductive ribbon 505 required. Thus, the tension of the conductive ribbon 595 between the ribbon handler 502 and the soldering chassis 504 can be maintained. Otherwise, the tension of the conductive ribbon would increase as the soldering device 200 continuously moves together with the soldering chassis 504 along the direction as shown by arrow 508 to pull an additional length of the conductive ribbon 505 from the ribbon handler 502.

Next, the soldering chassis 504 is lowered until the wheel 208 of the soldering device 200 forms a soft-touch with the solar cell 501. The soldering chassis 504 then moves together with the soldering device 200 along the positioning arm 515 in a direction opposite to arrow 508 to solder the extended length of the conductive ribbon 505 to the solar cell 501.

After the conductive ribbon 505 is soldered to the solar cell 501, the soldering chassis 504 is raised before the support device 501 moves in a direction as shown by arrow 508 so that a new solar cell can be placed next to the solar cell 501. Thus, the integrated mechanism 500 may be used for laying and soldering another length of the conductive ribbon 505 from the ribbon handler 502 to the new solar cell. This effectively interconnects the solar cell 501 electrically with the new solar cell.

Optionally, the integrated mechanism 500 may also include a temperature sensor (shown in FIG. 5 as an IR heat sensor 510) for measuring temperature of a corresponding section of the conductive ribbon and/or the corresponding section of the solar cell just before it is soldered to the solar cell 501. The temperature as measured by the IR heat sensor 510 can then be fed back to another processor 509, which is connected between the IR head sensor 510 and the soldering chassis 504, to adjust the speed at which the soldering device 200 moves together with the soldering chassis 504 when soldering the conductive ribbon 505 to the solar cell 501 during operation. Alternatively, the frequency of the alternating current generator that connects to the inductor loop 206 may also be adjusted accordingly. By providing a closed feed-back loop during operation, the integrated mechanism 500 advantageously minimizes the need for human intervention in adjusting the operating parameters.

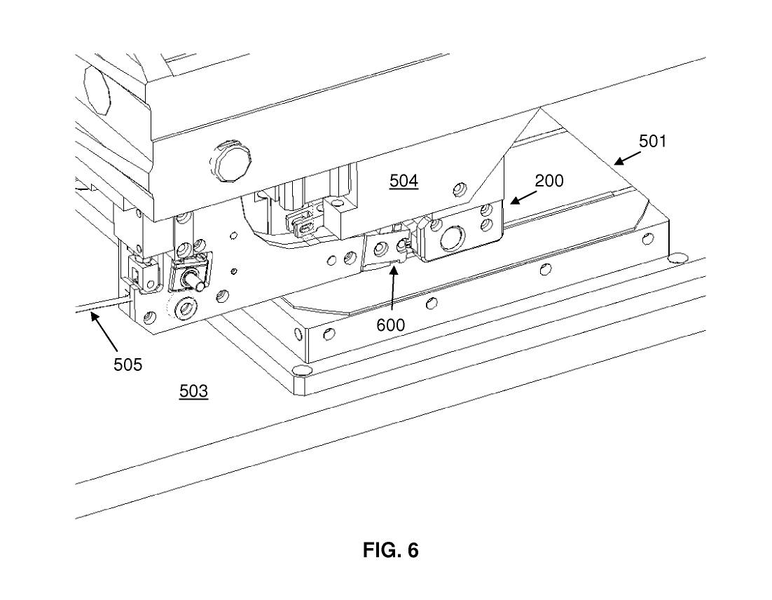

FIG. 6 shows a side view of the soldering chassis 504, which houses the soldering device 200. Specifically, it can be seen that the soldering chassis 504 comprises a cutting device (shown as a blade 600) for detaching a desired length of conductive ribbon 505 from the reel of the conductive ribbon 505 after the desired length of conductive ribbon 505 has been dispensed from the ribbon handler 502.

By using the integrated mechanism 500 for laying and soldering the conductive ribbon 505 to the solar cell 501, the processes of tabbing and stringing the solar cell 501 to one or more solar cells can be completed in a single operation. Advantageously, the production efficiency of solar panel fabrication may be enhanced compared with the case in which the processes of tabbing and stringing of solar cells are sequentially and separately performed.

The integrated mechanism 500 could be used not only for electrically interconnecting between a plurality of solar cells to form a string, but also for electrically interconnecting between a plurality of strings to form a solar array. It should also be appreciated that other embodiments of the integrated mechanism 500 could also be envisaged. For instance, the slot 507 is not limited to a linear slot but could also other configurations so long as the movable pulley 560e is movable along those other configurations to maintain a constant tension of the conductive ribbon 505 between the ribbon handler 502 and the soldering device 200.

It is also envisaged that the wheel 208 may be installed outside of the inductor loop 206. For instance, the wheel 208 may either be positioned at the front of the soldering device 200 that is adjacent to the front section 201a of the inductor loop 206, or at the back of the soldering device 200 that is adjacent to the back section 201b of the inductor loop 206. In such an instance, a piece of diamagnetic material may be installed within the inductor loop 206 in place of the wheel 208, to concentrate the magnetic field that is generated by the inductor loop 206 for greater heat generation. Preferably, the piece of diamagnetic material comprises a through-hole, which allows the IR heat sensor 510 to measure a temperature of the section of the conductive ribbon as it is being soldered to the solar cell.

1. An apparatus for electrically interconnecting a plurality of solar cells, the apparatus comprising:
a roller operative to roll along a solar cell to press an electrical conductor against an electrical contact of the solar cell, the electrical conductor being for electrically interconnecting the solar cell with one or more other solar cells; and
a heat-generating device arranged and configured to provide heat for soldering the electrical conductor to the electrical contact of the solar cell while the roller is pressing the electrical conductor against the electrical contact of the solar cell.

2. The apparatus of claim 1, wherein the heat-generating device comprises an inductor loop for generating a magnetic field to induce an electrical current in the electrical contact of the solar cell to thereby generate heat for soldering the electrical conductor thereto.

3. The apparatus of claim 2, wherein the inductor loop is arranged around the roller.

4. The apparatus of claim 2, wherein the roller is made up of diamagnetic material for concentrating the magnetic field generated by the inductor loop within a space enclosed by the inductor loop.

5. The apparatus of claim 2, wherein the inductor loop comprises a plurality of sections, each section being inclined at an angle with respect to a surface of the solar cell in a direction along which the roller rolls along the solar cell.

6. The apparatus of claim 5, wherein each section of the inductor loop is inclined at an angle of not more than 45 degrees with respect to the surface of the solar cell.

7. The apparatus of claim 2, wherein the roller comprises a plurality of diamagnetic O-rings around a circumference of the roller.

8. The apparatus of claim 2, wherein the roller comprises a plurality of diamagnetic cores.

9. The apparatus of claim 1, wherein the heat-generating device is a laser-emitting device operative to emit laser for providing heat to solder the electrical conductor to the electrical contact of the solar cell.

10. The apparatus of claim 1, further comprising a chassis for housing the heat-generating device and the roller.

11. The apparatus of claim 10, wherein the chassis is driven by a motor.

12. A method of electrically interconnecting a plurality of solar cells, the method comprising the steps of:
laying an electrical conductor on an electrical contact of a solar cell, the electrical conductor being for electrically interconnecting the solar cell with one or more other solar cells;
pressing the electrical conductor against the electrical contact of the solar cell; and
providing heat to solder the electrical conductor to the electrical contact of the solar cell,
wherein the step of pressing the electrical conductor against the electrical contact of the solar cell comprises rolling a roller along the solar cell to press the electrical conductor against the electrical contact of the solar cell as heat is being provided to solder the electrical conductor to the solar cell.

13. The method of claim 12, wherein the step of providing heat to solder the electrical conductor to the electrical contact of the solar cell comprises generating a magnetic field with an inductor loop to induce an electrical current in the electrical contact of the solar cell to thereby generate heat for soldering the electrical conductor thereto.

14. The method of claim 13, wherein the step of providing heat to solder the electrical conductor to the electrical contact of the solar cell comprises intermittently generating the magnetic field with the inductor loop to solder the electrical conductor to selective portions of the electrical contact of the solar cell.

15. The method of claim 12, wherein the step of providing heat to solder the electrical conductor to the electrical contact of the solar cell comprises emitting a laser with a laser-emitting device to generate heat for soldering the electrical conductor to the electrical contact of the solar cell.

16. The method of claim 15, wherein the step of providing heat to solder the electrical conductor to the electrical contact of the solar cell comprises intermittently generating the laser with the laser-generating device to solder the electrical conductor to selective portions of the electrical contact of the solar cell.

17. A mechanism for laying and soldering an electrical conductor onto a solar cell, the mechanism comprising:
the apparatus of claim 1 for laying and soldering the electrical conductor onto the solar cell; and
a dispensing device for providing the electrical conductor to the apparatus of claim 1.

18. The mechanism of claim 17, further comprising:
a temperature sensor for measuring temperature of a section of the electrical conductor before the section of the electrical conductor is soldered to the solar cell; and
a processor configured to adjust a speed at which the apparatus of claim 1 moves to solder the electrical conductor to the solar cell, based on the temperature as measured by the temperature sensor.

19. The mechanism of claim 17, further comprising a cutting device for detaching the electrical conductor from the dispensing device.

20. The mechanism of claim 19, further comprising a chassis for housing the cutting device and the apparatus of claim 1.
